(19) United States
(12) Patent Application Publication
(10) Pub. No.: US 2026/0244755 A1
(43) Pub. Date: Aug. 20, 2026

(54) ARTIFICIAL INTELLIGENCE ENABLED SYSTEM AND METHOD FOR REAL-TIME CLOUD RESOURCE MONITORING AND VISUALIZATION

(71) Applicants: RAVI TIYYAGURA, Franklin, TN (US); SRIKANTH REDDY TIYYAGURA, Franklin, TN (US)

(72) Inventors: RAVI TIYYAGURA, Franklin, TN (US); SRIKANTH REDDY TIYYAGURA, Franklin, TN (US)

(21) Appl. No.: 19/055,053

(22) Filed: Feb. 17, 2025

(51) Int. Cl. G06F 21/57; G06F 9/54

(52) U.S. Cl. CPC G06F 21/577; G06F 9/546; G06F 2209/547; G06F 2221/033

(57) ABSTRACT

Exemplary embodiments of the present disclosure relate to an AI-enabled platform for real-time cloud resource monitoring, visualization, and optimization. The platform features a cloud resource visualization module that delivers dynamic, real-time views of applications, their resources, and associated operational metrics, including performance, security, compliance, and costs. Users gain a holistic understanding of resource interdependencies and application health through detailed, interactive visualizations. The platform connects to a cloud server hosting an Operational Twin Engine, which integrates data from Infrastructure-as-Code (IaC) tools, cloud provider APIs, security frameworks, compliance systems, and cost management utilities. Advanced AI techniques, such as Graph Neural Networks (GNNs) for predictive analytics and attack path detection, and Generative AI for resource optimization and compliance forecasting, enhance the system's capabilities. The resulting Operational Twin provides dynamic updates, actionable insights, and AI-driven recommendations for improving security, compliance, and financial operations, empowering organizations to achieve greater clarity, efficiency, and control.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present disclosure generally relates to the field of cloud computing and infrastructure monitoring. More particularly, the present disclosure relates to a system and method for real-time monitoring and visualization of cloud resources, leveraging artificial intelligence technologies. Additionally, the present disclosure addresses the integration of advanced data aggregation, AI-driven insights, and dynamic visualizations to provide comprehensive operational visibility. It is particularly relevant to applications involving real-time cloud resource monitoring, security analysis, cost optimization, and compliance management across distributed computing environments.

### BACKGROUND

As organizations increasingly migrate to multi-cloud environments, they encounter significant challenges in managing diverse cloud resources, ensuring security, maintaining compliance, and optimizing costs. These challenges are compounded by the fragmentation of cloud management tools, which often focus on individual aspects such as security, cost, or compliance, without providing an integrated, unified view of cloud operations. This lack of comprehensive visibility across various cloud platforms results in inefficiencies and missed opportunities for optimization, creating a substantial technical problem for organizations managing complex cloud ecosystems.

Existing solutions address specific domains but fail to deliver a holistic view of the entire cloud infrastructure. For instance, Cloud Security Posture Management (CSPM) tools, such as Wiz and AWS Security Hub, are focused on security compliance and identifying vulnerabilities in cloud configurations. However, they do not integrate with cost management or governance tools, forcing businesses to rely on multiple, siloed solutions that require complex integration. Similarly, cloud cost management tools like AWS Cost Explorer or Cloud Health offer insights into spending but are reactive, providing information only after resources have been deployed, leaving organizations to deal with costs incurred rather than preventing them.

Cloud governance solutions, such as CloudCheckr and AWS Organizations, help manage policies across multi-cloud environments, but they lack real-time monitoring capabilities and do not integrate well with security or cost optimization tools. Likewise, infrastructure monitoring tools like Datadog or New Relic focus on performance monitoring but fail to provide AI-driven, proactive insights into security, compliance, or cost optimization.

The technical problem inherent in these existing solutions is the fragmentation of cloud management across different operational domains. Each tool is designed to handle a specific aspect of cloud management security, performance, governance, or cost without integrating or correlating data between domains. As a result, organizations are forced to operate and analyze each domain separately, often using multiple interfaces and data structures, which leads to inefficiencies and operational silos.

Additionally, current cloud management solutions generally adopt a reactive approach, only providing insights or corrective actions after an issue has occurred. For example, security tools may only detect vulnerabilities after they have been exposed to risk, and cost management tools typically analyze spending only after it has been incurred. This approach limits an organization's ability to optimize its cloud resources proactively, missing out on opportunities for cost reduction, risk mitigation, and performance improvement before problems arise. Furthermore, the lack of integration across domains security, governance, cost management, and compliance results in incomplete visibility and decision-making gaps. Organizations are unable to visualize the interdependencies between these domains, hindering their ability to manage cloud operations in a comprehensive, holistic manner.

In the light of the aforementioned discussion, there exists a need for a system with novel methodologies that would overcome the above-mentioned challenges.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards an artificial intelligence enabled system and method for real-time cloud resource monitoring and visualization.

An objective of the present disclosure is directed towards an advanced cloud resource management platform (Operational Twin) that offers a unified, real-time, and visual representation of an organization's cloud infrastructure.

Another objective of the present disclosure is directed towards a system that creates an “Operational Twin” of cloud resources, enabling the visualization, monitoring, and analysis of cloud infrastructure in real time.

Another objective of the present disclosure is directed towards a system that synthesizes data from diverse sources, such as architectural designs, code repositories, infrastructure-as-code (IaC), security frameworks, compliance systems, and cost management tools, to integrate and provide a holistic view of cloud resources and operations.

Another objective of the present disclosure is directed towards a system that provides real-time insights into cloud operations, facilitating efficient management of security, performance, compliance, and cost optimization across multi-cloud environments.

Another objective of the present disclosure is directed towards a system that aggregates and visualizes data from multiple sources, ensuring users have a comprehensive, up-to-date view of their entire cloud ecosystem, which enhances decision-making and operational efficiency.

Another objective of the present disclosure is directed towards a system that aggregates data from multiple sources into a single interface, providing real-time visibility and enabling deep insights into the relationships and interdependencies between cloud resources, applications, and services.

Another objective of the present disclosure is directed towards a system that leverages Generative AI and Graph Neural Networks (GNNs) to automate security analysis, cost optimization, and operational governance within cloud environments.

Another objective of the present disclosure is directed towards a system that provides a holistic, visual mapping of an organization's cloud footprint, enhancing operational efficiency, security, and compliance by providing a comprehensive, real-time view of cloud resources.

Another objective of the present disclosure is directed towards filling existing gaps in cloud management by offering a unified interface that visually represents cloud resources and their interdependencies, allowing organizations to manage complex cloud environments more securely and efficiently.

Another objective of the present disclosure is directed towards a system that enables users to access all critical cloud resource information such as security, cost, compliance, and performance through a centralized visual interface, eliminating the need to navigate multiple tools or screens.

Another objective of the present disclosure is directed towards streamlining cloud operations, providing deeper insights, and enhancing decision-making through an intuitive, real-time interface that integrates all aspects of cloud management.

Another objective of the present disclosure is directed towards a system that creates an Operational Twin of cloud environments, providing a unified, real-time visual representation of cloud resources, their relationships, and dependencies.

Another objective of the present disclosure is directed towards a system that aggregates data from diverse sources, including architectural designs, Infrastructure-as-Code (IaC), security frameworks, and cost management tools, to deliver comprehensive operational visibility.

Another objective of the present disclosure is directed towards a system that integrates data into a single pane of glass, allowing users to monitor and analyze cloud resources efficiently and effectively.

Another objective of the present disclosure is directed towards addressing existing cloud management challenges by offering a solution that enhances visibility, simplifies analysis, and improves decision-making through a centralized, real-time interface.

Another objective of the present disclosure is directed towards a system that introduces a novel process by creating an Operational Twin for real-time cloud operations, consolidating key aspects such as security, compliance, cost, and operational efficiency into a single unified view.

Another objective of the present disclosure is directed towards a system that centralizes and automates cloud operations across multiple domains, including security, governance, cost, and compliance, through a proactive, AI-driven approach.

Another objective of the present disclosure is directed towards a system that employs real-time data aggregation, AI-driven recommendations, and automated corrective actions to streamline cloud resource management.

Another objective of the present disclosure is directed towards a system that enables the automatic generation of infrastructure-as-code (IaC) to enhance operational efficiency and reduce manual effort in cloud resource provisioning.

Another objective of the present disclosure is directed towards providing a significant improvement over existing cloud management systems by integrating multiple operational areas into one comprehensive, proactive platform, enabling enhanced visibility and operational clarity.

Another objective of the present disclosure is directed towards a system that provides a real-time, unified view of an organization's cloud infrastructure, enabling detailed visualization of operational data, relationships, dependencies, and interconnections between cloud resources.

Another objective of the present disclosure is directed towards enhancing operational visibility, health, performance, and security of cloud environments by reducing reliance on multiple fragmented tools.

Another objective of the present disclosure is directed towards offering a unified system for cloud management, integrating security, governance, cost, and compliance into a single comprehensive interface, unlike siloed solutions focused on singular domains.

Another objective of the present disclosure is directed towards improving operational efficiency and decision-making by eliminating the need to manage multiple tools and interfaces.

Another objective of the present disclosure is directed towards providing a real-time digital twin of an organization's cloud ecosystem, offering dynamic visual monitoring of resource health, performance, and security, in contrast to static dashboards or reports offered by existing solutions.

Another objective of the present disclosure is directed towards a centralized system for enterprise cloud management, enabling businesses to manage diverse cloud resources across AWS, Azure, Google Cloud, and other platforms with real-time visibility, proactive security, and cost optimization.

Another objective of the present disclosure is directed towards a system that enhances cloud security and governance by continuously monitoring security risks using Graph Neural Networks (GNNs), automating governance enforcement, and providing real-time attack path analysis and predictive breach prevention.

Another objective of the present disclosure is directed towards a system tailored for financial services that automate compliance reporting, continuously monitors regulatory risks, and safeguards sensitive customer data in real-time under strict compliance frameworks like PCI-DSS and SOX.

Another objective of the present disclosure is directed towards a system for healthcare compliance and security, providing automated audit-ready reports and real-time monitoring of vulnerabilities to ensure adherence to frameworks like HIPAA and HITECH, protecting sensitive patient data from breaches.

Another objective of the present disclosure is directed towards cost optimization for cloud-native startups and SMBs, utilizing AI-driven cost forecasting and resource optimization to minimize wasteful spending and ensure scalable, high-performance cloud operations.

Another objective of the present disclosure is directed towards enabling AI-driven AIOps for autonomous cloud operations, allowing the system to self-heal, autonomously optimize resources, and dynamically scale based on real-time demand without human intervention.

Another objective of the present disclosure is directed towards managing quantum cloud infrastructure, providing real-time visibility, security, and optimization as quantum computing becomes commercially viable.

Another objective of the present disclosure is directed towards smart city and IoT management, where the platform extends to manage distributed cloud and edge resources, offering real-time insights, security, and optimization for city-scale IoT networks.

Another objective of the present disclosure is directed towards supporting autonomous vehicle cloud management, enabling real-time data processing, communication, and machine learning updates for autonomous fleets while ensuring operational security and optimal resource allocation.

Another objective of the present disclosure is directed towards managing edge computing and 5G network infrastructure, providing real-time monitoring of geographically distributed edge nodes operating in tandem with 5G networks.

Another objective of the present disclosure is directed towards incorporating carbon emission monitoring into cloud operations, allowing organizations to minimize their environmental impact by optimizing resource consumption and reducing their carbon footprint.

Another objective of the present disclosure is directed towards a unified cloud management platform that integrates security, compliance, governance, and cost management into a single real-time framework, eliminating fragmented approaches and enabling strategic and operational advantages.

Another objective of the present disclosure is directed towards leveraging Graph Neural Networks (GNNs) for dynamic, predictive analytics to analyze cloud resource interdependencies, optimize workloads, and predict potential performance bottlenecks before they occur.

Another objective of the present disclosure is directed towards a system that incorporates proactive security automation, using GNN-based overlays to predict attack paths, calculate business risk scores, and provide automated remediation workflows.

Another objective of the present disclosure is directed towards providing Shift-Left FinOps capabilities by leveraging Generative AI to optimize costs during the design phase of cloud applications, addressing inefficiencies before deployment.

Another objective of the present disclosure is directed towards enabling real-time compliance automation, dynamically mapping resource changes against compliance frameworks, generating audit-ready reports, and integrating custom policies.

Another objective of the present disclosure is directed towards providing multi-domain compliance insights, integrating cross-industry regulatory frameworks such as HIPAA, GDPR, and SOC2 into a unified dashboard for holistic compliance management.

Another objective of the present disclosure is directed towards an Operational Twin Engine that converts real-time aggregated data into an interactive visual map of cloud resources, highlighting interdependencies, attack paths, and compliance risks.

Another objective of the present disclosure is directed towards enabling dynamic decision support by offering interactive visuals linked to automated remediation workflows, making visual insights actionable in real-time.

Another objective of the present disclosure is directed towards providing scalable multi-cloud governance, ensuring consistent policies and insights across multi-cloud and hybrid-cloud environments without being tied to a specific infrastructure.

Another objective of the present disclosure is directed towards introducing an AI-driven cost intelligence system at design time, predicting costs and optimizations during cloud application development to address inefficiencies at their root.

Another objective of the present disclosure is directed towards offering a unified visualization framework that surpasses static dashboards, allowing users to observe, interact with, and act upon cloud resource insights in real time.

According to an exemplary aspect of the present disclosure, a computing device comprising a processor for executing instructions from a cloud resource visualization module located within the computing device, wherein the cloud resource visualization module is configured to display real-time visualizations of cloud resources, including operational states, interdependencies, and relationships, wherein the computing device communicatively connected with a cloud server over a network.

According to another exemplary aspect of the present disclosure, the cloud server comprises an operational twin engine for executing instructions from a cloud resource processing module, whereby the cloud resource processing module is configured to aggregate data from a plurality of sources, including infrastructure-as-Code (IaC) tools, cloud provider application programming interfaces (APIs), logs and event records, security frameworks and compliance systems, cost management tools.

According to another exemplary aspect of the present disclosure, the cloud resource processing module is configured to process the aggregated data using advanced artificial intelligence (AI) techniques, including Graph Neural Networks (GNNs) for predictive analytics, relationship mapping, and attack path analysis; Generative AI for real-time optimization of resource allocation, compliance adherence, and cost forecasting.

According to another exemplary aspect of the present disclosure, the cloud resource processing module generates a real-time operational twin of the cloud ecosystem with visual representations of cloud resource relationships, performance metrics, compliance statuses, security vulnerabilities, dynamic updates of changes in the cloud environment, including new deployments, configuration changes, and detected issues, whereby the cloud resource processing module transmits the generated real-time operational twin of the cloud ecosystem to the computing device over the network.

According to another exemplary aspect of the present disclosure, the cloud resource visualization module on the computing device configured to provide real-time, interactive visualizations of the operational twin, including overlays for compliance, security, and cost metrics and presents AI-driven insights and recommendations for proactive decision-making, such as security remediation, resource optimization, and compliance corrections, wherein the cloud resource visualization module configured to enable the user to interact with visual elements, including modifying configurations, initiating remediation workflows, and generating compliance reports.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting a schematic representation of a system for real-time cloud resource monitoring and visualization, in accordance with one or more exemplary embodiments.

FIG. 2 is a block diagram depicting an embodiment of the cloud resource visualization module 112 as shown in FIG. 1, in accordance with one or more exemplary embodiments.

FIG. 3 is a block diagram depicting an embodiment of the cloud resource processing module 114 as shown in FIG. 1, in accordance with one or more exemplary embodiments.

FIG. 4 is a flow diagram depicting a method for real-time cloud resource monitoring and visualization, in accordance with one or more exemplary embodiments.

FIG. 5 is a flow diagram depicting a method for integrating predictive GNN analytics, AI-driven insights, and automated compliance reporting to deliver cross-domain cloud infrastructure optimization, in accordance with one or more exemplary embodiments.

FIG. 6 is a flow diagram depicting a method for proactive attack path detection and remediation using Graph Neural Networks (GNNs), integrated into a real-time security overlay for multi-cloud systems

FIG. 7 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

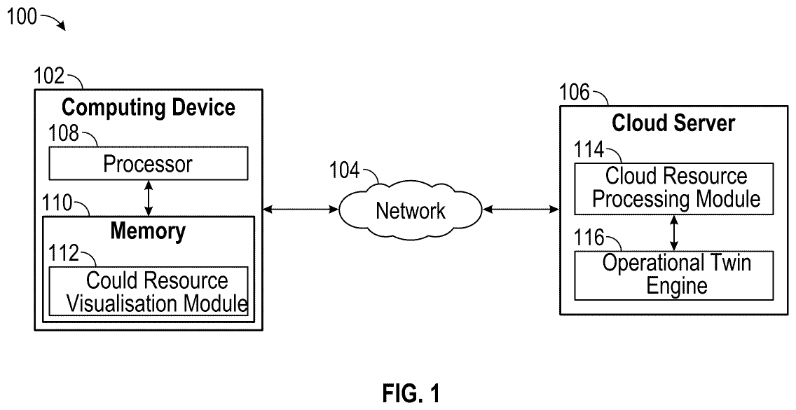

Referring to FIG. 1 is a block diagram 100 depicting a schematic representation of a system for real-time cloud resource monitoring and visualization, in accordance with one or more exemplary embodiments. The system 100 includes a computing device 102, a network 104, a cloud server 106, a processor 108, a memory 110, a cloud resource visualization module 112, a cloud resource processing module 114, and an operational twin engine 116. The system 100 enables organizations to manage their cloud resources effectively by providing real-time insights, actionable recommendations, and dynamic visualizations of their cloud infrastructure. The system 100 integrates key functionalities such as data aggregation, AI-driven analytics, security assessments, and compliance checks into a cohesive platform.

The computing device 102 may include but is not limited to, a personal digital assistant, smartphones, personal computers, a mobile station, computing tablets, a handheld device, an internet enabled calling device, an internet enabled calling software, a telephone, a mobile phone, a digital processing system, and so forth. The computing devices 102 may include the processor 108 in communication with a memory 110. The processor 108 may be a central processing unit. The memory 110 is a combination of flash memory and random-access memory. The processor 108 may execute instructions and process data within the system.

The memory 110 may be configured to store program instructions, data, and temporary information needed for system operations. The computing device 102 may be communicatively connected with the cloud server 106 via the network 104. The network 104 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure.

Although the computing device 102 is shown in FIG. 1, an embodiment of the system 100 may support any number of computing devices. The computing device 102 supported by the system 100 is realized as a computer-implemented or computer-based device having the hardware or firmware, software, and/or processing logic needed to carry out the computer-implemented methodologies described in more detail herein.

The cloud resource visualization module 112 may be any suitable applications downloaded from GOOGLE PLAY® (for Google Android devices), Apple Inc.'s APP STORE® (for Apple devices), or any other suitable database. The cloud resource visualization module 112 may be a desktop application which runs on Windows or Linux or any other operating system and may be downloaded from a webpage or a CD/USB stick etc. In some embodiments, the cloud resource visualization module 112 may be software, firmware, or hardware that is integrated into the computing device 102. The computing device 102 may present a web page to the user by way of a browser, wherein the webpage comprises a hyper-link may direct the user to uniform resource locator (URL).

The computing device 102 may be configured to serve as the user interface for interacting with the system. The computing device 102 may include a laptop, desktop, tablet, or any other computing platform that enables users to visualize cloud resource operations, receive actionable insights, and perform corrective actions. The computing device 102 interacts with the cloud server 106 via the network 104, ensuring bidirectional communication and data flow. The computing device 102 includes the processor 108 and the memory 110. The processor 108 may be configured to execute instructions related to the operation of the cloud resource visualization module 112, which is also hosted on the computing device 102. The memory 110 may be configured to store data and application instructions required for rendering the real-time visualizations and managing user interactions. The cloud resource visualization module 112 may be configured to provide a dynamic and interactive interface that allows users to monitor cloud resource relationships, interdependencies, and operational statuses. The cloud resource visualization module 112 enables users to view AI-driven recommendations, such as resource optimizations, compliance adherence measures, and security improvements, while also allowing them to initiate corrective actions or configure system parameters. The network 104 facilitates communication between the computing device 102 and the cloud server 106. The network 104 may include wired or wireless communication technologies such as Ethernet, Wi-Fi, or cellular networks. The network 104 ensures that the data aggregated and processed on the cloud server 106 is transmitted seamlessly to the computing device 102 for real-time visualization and user interaction. The cloud server 106 may be the backend of the system and is responsible for hosting the cloud resource processing module 114 and the Operational Twin Engine 116. The cloud server 106 may be configured to aggregate data from various sources, process it using advanced AI techniques, and generate insights for security, compliance, cost optimization, and governance. The cloud resource processing module 114 may be configured to collect data from diverse sources such as Infrastructure-as-Code (IaC) tools, cloud provider APIs, application logs, security frameworks, and compliance systems. The cloud resource processing module 114 ensures that the aggregated data is up-to-date and comprehensive, providing the foundation for the creation of the Operational Twin.

The Operational Twin Engine 116 hosted within the cloud server 106, forms the core of the system. The Operational Twin Engine 116 may be configured to create and maintain a digital twin of the cloud ecosystem. The digital twin represents the relationships, dependencies, and operational states of cloud resources, including network interdependencies, database connections, and storage allocations. The Operational Twin Engine 116 generates real-time visual representations of the cloud infrastructure, maps security vulnerabilities and risks onto these visualizations, and overlays compliance-related data, enabling users to identify and address potential issues proactively. Through the collaboration between the cloud resource processing module 114 and the Operational Twin Engine 116, the system provides seamless integration of aggregated data and AI-driven analysis. This processed information is transmitted to the cloud resource visualization module 112 on the computing device 102 via the network 104. The cloud resource visualization module 112 dynamically updates the user-facing interface, ensuring that users have access to the latest insights and operational data. The interactions between the computing device 102, cloud server 106, and their respective modules ensure that users can monitor and manage their cloud resources efficiently. For example, a user interacting with the computing device 102 can initiate a remediation workflow or modify cloud configurations based on the insights displayed. These actions are transmitted through the network 104 to the cloud resource processing module 114, which processes the requests and updates the Operational Twin Engine 116 accordingly. FIG. 1 illustrates an integrated system for real-time cloud resource monitoring and visualization. The system's modular design and seamless interaction between its components ensure efficient and proactive cloud management, empowering organizations to address challenges related to security, compliance, cost, and governance in a unified and dynamic manner.

In accordance with one or more exemplary embodiments of the present disclosure, the computing device 102 may include the processor 108 for executing instructions from the cloud resource visualization module 112 located within the computing device 102. The cloud resource visualization module 112 may be configured to display real-time visualizations of cloud resources, including operational states, interdependencies, and relationships. The computing device 102 may be communicatively connected with the cloud server 106 over the network. The cloud server 106 may include the operational twin engine 116 for executing instructions from the cloud resource processing module 114. The cloud resource processing module 114 may be configured to aggregate data from a plurality of sources, including infrastructure-as-Code (IaC) tools, cloud provider application programming interfaces (APIs), logs and event records, security frameworks and compliance systems, cost management tools. The cloud resource processing module may be configured to process the aggregated data using advanced artificial intelligence (AI) techniques, including Graph Neural Networks (GNNs) for predictive analytics, relationship mapping, and attack path analysis; Generative AI for real-time optimization of resource allocation, compliance adherence, and cost forecasting. The cloud resource processing module 114 may be configured to generate a real-time operational twin of the cloud ecosystem with visual representations of cloud resource relationships, performance metrics, compliance statuses, security vulnerabilities, dynamic updates of changes in the cloud environment, including new deployments, configuration changes, and detected issues. The cloud resource processing module 114 may transmit the generated real-time operational twin of the cloud ecosystem to the computing device 102 over the network 104. The cloud resource visualization module 114 on the computing device 102 may be configured to provide real-time, interactive visualizations of the operational twin, including overlays for compliance, security, and cost metrics, and presents AI-driven insights and recommendations for proactive decision-making, such as security remediation, resource optimization, and compliance corrections. The cloud resource visualization module 112 may be configured to enable the user to interact with visual elements, including modifying configurations, initiating remediation workflows, and generating compliance reports.

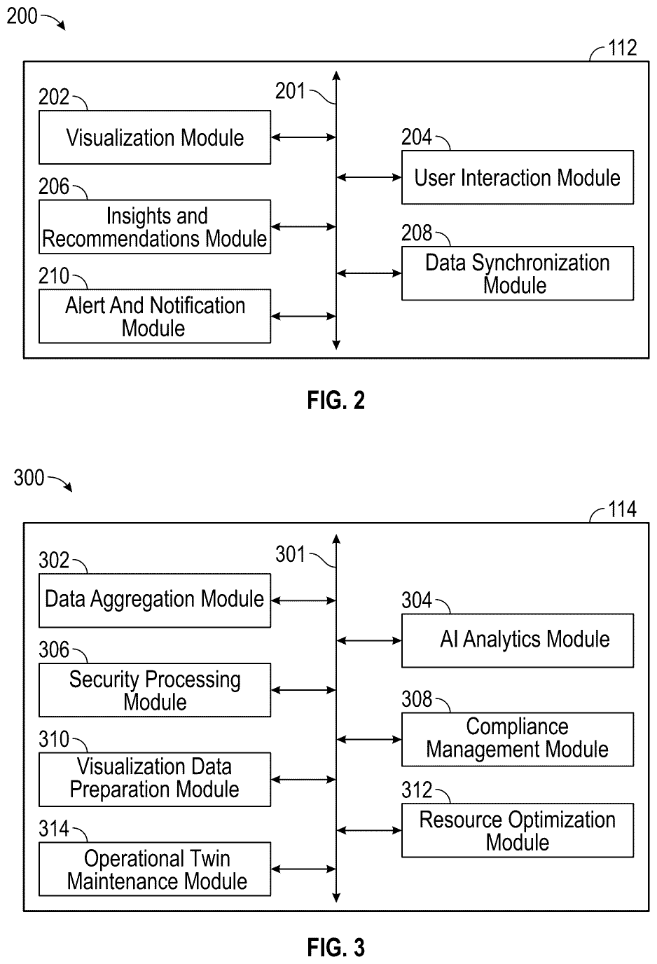

Referring to FIG. 2 is a block diagram 200 depicting an embodiment of the cloud resource visualization module 112 as shown in FIG. 1, in accordance with one or more exemplary embodiments. The cloud resource visualization module 112 includes a visualization module 202, a user interaction module 204, an insights and recommendations module 206, a data synchronization module 208, and an alert and notification module 210. The bus 201 may include a path that permits communication among the modules of the cloud resource visualization module 112 installed on the computing device 102. The term “module” is used broadly herein and refers generally to a program resident in the memory 110 of the computing device 102.

The visualization module 202 may be configured to provide a dynamic and interactive interface for real-time visualizations of cloud resources. The visualization module 202 enables users to view the operational state, interdependencies, and relationships of cloud resources, such as network connections, database interactions, and resource allocations. The visualization module 202 may also be configured to render graphical representations of security overlays, compliance statuses, and cost metrics derived from the operational twin maintained by the cloud server 106. These visualizations allow users to easily identify vulnerabilities, compliance gaps, or inefficient resource utilization within their cloud environment. The visualization module 202 may be configured to adapt its display dynamically based on user inputs or changes in real-time data received from the cloud server 106. For example, it may adjust the visual elements to highlight critical alerts, resource bottlenecks, or predicted issues. The user interaction module 204 may be configured to handle user inputs and facilitate interactions with the system. The user interaction module 204 enables users to initiate actions such as applying remediation workflows, modifying cloud configurations, or requesting specific insights. The user interaction module 204 may also be configured to support intuitive interaction methods, such as drag-and-drop operations, dropdown menus, and on-screen controls, to simplify user engagement. Additionally, the user interaction module 204 ensures that user commands are processed and transmitted to the cloud server 106 for execution, maintaining a responsive and interactive experience.

The insights and recommendations module 206 may be configured to present AI-driven insights and actionable recommendations to users. These insights may include suggestions for resource optimization, cost reductions, compliance adherence, and security improvements. The insights and recommendations module 206 may also be configured to display prioritized actions based on real-time analysis conducted by the cloud server 106. For instance, it may recommend scaling resources in response to increasing workloads or addressing compliance violations that pose the highest regulatory risks. The insights and recommendations module 206 may be configured to provide contextual explanations for the recommendations, helping users understand the rationale behind suggested actions and enabling informed decision-making. The data synchronization module 208 may be configured to synchronize real-time data between the cloud server 106 and the cloud resource visualization module 112. The data synchronization module 208 ensures that the visualizations and insights displayed on the user interface reflect the most current operational state of the cloud environment. The data synchronization module 208 may also be configured to manage the efficient transfer of large datasets, ensuring minimal latency in updating the visual interface. For example, it may employ techniques such as data caching and incremental updates to optimize the synchronization process. The data synchronization module 208 may be configured to handle error detection and recovery mechanisms to ensure consistent and accurate data synchronization, even in the presence of network disruptions. The alert and notification module 210 may be configured to generate real-time alerts and notifications for significant events or issues within the cloud environment. These alerts may include security vulnerabilities, compliance violations, cost anomalies, or resource performance degradation. The alert and notification module 210 may also be configured to prioritize and categorize alerts based on severity, ensuring that critical issues are highlighted for immediate attention. For example, it may display high-priority alerts, such as a detected attack path, at the top of the interface, while lower-priority issues, like minor cost inefficiencies, are shown in secondary notifications. The alert and notification module 210 may be configured to provide customizable notification settings, enabling users to define preferences for the types of alerts they wish to receive and the communication channels through which they are delivered (e.g., email, SMS, or in-app notifications).

Referring to FIG. 3 is a block diagram 300 depicting an embodiment of the cloud resource processing module 114 as shown in FIG. 1, in accordance with one or more exemplary embodiments. The cloud resource processing module 114 includes a bus 301, a data aggregation module 302, an AI analytics module 304, a security processing module 306, a compliance management module 308, a visualization data preparation module 310, a resource optimization module 312, and an operational twin maintenance module 314. The bus 301 may include a path that permits communication among the modules of the cloud resource processing module 114 installed on the cloud server 106.

The data aggregation module 302 may be configured to collect and aggregate data from diverse sources, such as Infrastructure-as-Code (IaC) tools, cloud provider APIs, application logs, and compliance frameworks. By unifying data from these sources, the data aggregation module 302 ensures that the system has access to real-time and accurate information about the cloud ecosystem. The data aggregation module 302 may also normalize the data to ensure consistency across various formats, allowing for seamless downstream processing. The data aggregation module 302 may detect and resolve data inconsistencies or gaps, ensuring that only high-quality data is passed on to the subsequent modules. The AI analytics module 304 may be configured to analyze the aggregated data using advanced AI techniques such as Graph Neural Networks (GNNs) and Generative AI. The AI analytics module 304 identifies patterns, predicts resource bottlenecks, and provides actionable insights. For instance, the AI analytics module 304 may predict future performance issues based on workload trends or recommend cost-saving measures for underutilized resources. The AI Analytics Module 304 may evaluate potential security risks and suggest proactive measures to mitigate them. By leveraging AI-driven predictive analytics, the AI analytics module 304 ensures that the system operates efficiently and remains adaptable to dynamic cloud environments. The security processing module 306 may be configured to evaluate the cloud environment's security posture by identifying vulnerabilities, mapping potential attack paths, and calculating business risk scores. The security processing module 306 automates many security-related tasks, such as detecting misconfigurations or implementing remediation workflows. For example, the security processing module 306 may identify a vulnerable configuration in a cloud resource and automatically generate recommendations to resolve the issue. The security processing module 306 integrates threat intelligence data to enhance its ability to detect and respond to emerging security threats in real-time.

The compliance management module 308 may be configured to map cloud resource configurations against regulatory frameworks such as GDPR, HIPAA, and SOC2. The compliance management module 308 ensures that the cloud environment remains compliant with industry standards and generates audit-ready reports. The compliance management module 308 plays a critical role in ensuring that the cloud environment adheres to regulatory requirements such as GDPR, HIPAA, and SOC2. The compliance management module 308 may be configured to map resource configurations against compliance frameworks and detect violations in real time. By generating audit-ready reports, it simplifies the compliance process for organizations. Furthermore, the Compliance Management Module 308 may allow organizations to define custom compliance rules based on their specific requirements, ensuring flexibility and adaptability across various industries. The visualization data preparation module 310 may be configured to process and format the data for display in the user-facing interface of the cloud resource visualization module 112. The visualization data preparation module 310 converts the aggregated and analyzed data into visual formats that are intuitive and actionable. For instance, the visualization data preparation module 310 may prepare the graphical representations of resource relationships, security overlays, and compliance statuses. By optimizing the data for rendering, the visualization data preparation module 310 ensures that the interface remains responsive and user-friendly. The resource optimization module 312 may be configured to provide recommendations for improving resource utilization, reducing costs, and maintaining performance. The resource optimization module 312 ensures that resources are allocated optimally based on workload demands. For example, it may identify underutilized resources and suggest their downsizing or reallocation. Additionally, the resource optimization module 312 may operate proactively during the design phase of cloud applications, enabling cost-effective and efficient resource planning.

The operational twin maintenance module 314 may be configured to create, update, and maintain the digital twin of the cloud environment. This digital twin serves as a real-time, virtual representation of the cloud ecosystem, including its resources, interdependencies, and operational states. The operational twin maintenance module 314 may also be configured to reflect real-time changes in the cloud environment, such as new resource deployments or configuration updates. The operational twin maintenance module 314 may also be configured to synchronize with the cloud resource visualization module 112 to ensure that users always have the most accurate and up-to-date view of their cloud ecosystem. The operational twin maintenance module 314 may also be configured to incorporate feedback from other modules, such as AI analytics module 304 and security processing module 306 to enhance the fidelity and usefulness of the digital twin. The operational twin maintenance module 314 may be configured to create and maintain a real-time digital representation of the cloud ecosystem. The operational twin maintenance module 314 may also be configured to update the digital twin dynamically as new resources are deployed or existing configurations change. By maintaining an accurate and up-to-date view of the cloud environment, the operational twin maintenance module 314 ensures that users have a clear and comprehensive understanding of their cloud infrastructure.

The operational twin maintenance module 314 may be configured to create, update, and maintain the digital twin of the cloud ecosystem. This digital twin serves as a real-time, virtual representation of cloud resources, including their relationships, dependencies, and operational states. The operational twin maintenance module 314 ensures that the digital twin dynamically reflects changes in the cloud environment, such as new resource deployments, configuration updates, or resource utilization shifts. The operational twin maintenance module 314 may also be configured to integrate with and receive input from other subsystems, such as the security processing module 306, compliance management module 308, and resource optimization module 312. For instance: It may interact with the security processing module 306 to overlay identified vulnerabilities, attack paths, and risk scores onto the digital twin. This ensures that users can visually identify and prioritize security concerns in the cloud environment. It may receive compliance data from the compliance management module 308 to reflect real-time compliance statuses within the digital twin. This integration enables users to view compliance violations directly within the operational map and take corrective actions promptly. It may utilize optimization insights from the resource optimization module 312 to adjust and display resource configurations, ensuring the digital twin reflects optimal utilization patterns and cost-effective resource allocations. The operational twin maintenance module 314 may also be configured to act as the central hub for integrating and synthesizing data from these subsystems, ensuring that the digital twin provides a comprehensive, real-time view of the cloud environment. By maintaining continuous synchronization with the AI analytics module 304 and the visualization data preparation module 310, it ensures that all visualizations and insights displayed to the user are both accurate and actionable. The operational twin maintenance module 314 not only serves as the foundation for visual mapping and operational insight generation but also facilitates seamless cross-domain integration, making the Operational Twin a unified representation of security, cost, compliance, and performance aspects within the cloud environment.

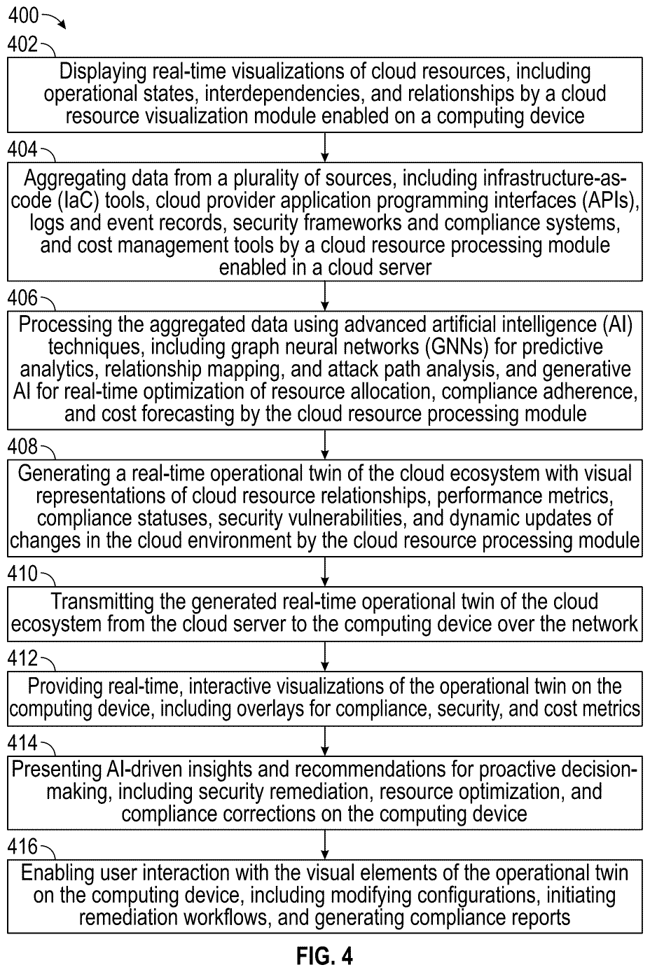

Referring to FIG. 4 is a flow diagram 400 depicting a method for real-time cloud resource monitoring and visualization, in accordance with one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The exemplary method 400 commences at step 402, displaying real-time visualizations of cloud resources, including operational states, interdependencies, and relationships by a cloud resource visualization module enabled on the computing device. Thereafter at step 404, aggregating data from a plurality of sources, including infrastructure-as-Code (IaC) tools, cloud provider application programming interfaces (APIs), logs and event records, security frameworks and compliance systems, and cost management tools by the cloud resource processing module enabled in the cloud server. Thereafter at step 406, processing the aggregated data using advanced artificial intelligence (AI) techniques, including Graph Neural Networks (GNNs) for predictive analytics, relationship mapping, and attack path analysis, and Generative AI for real-time optimization of resource allocation, compliance adherence, and cost forecasting by the cloud resource processing module. Thereafter at step 408, generating a real-time operational twin of the cloud ecosystem with visual representations of cloud resource relationships, performance metrics, compliance statuses, security vulnerabilities, and dynamic updates of changes in the cloud environment by the cloud resource processing module. Thereafter at step 410, transmitting the generated real-time operational twin of the cloud ecosystem from the cloud server to the computing device over the network. Thereafter at step 412, providing real-time, interactive visualizations of the operational twin on the computing device, including overlays for compliance, security, and cost metrics. Thereafter at step 414, presenting AI-driven insights and recommendations for proactive decision-making, including security remediation, resource optimization, and compliance corrections on the computing device. Thereafter at step 416, enabling user interaction with the visual elements of the operational twin on the computing device, including modifying configurations, initiating remediation workflows, and generating compliance reports.

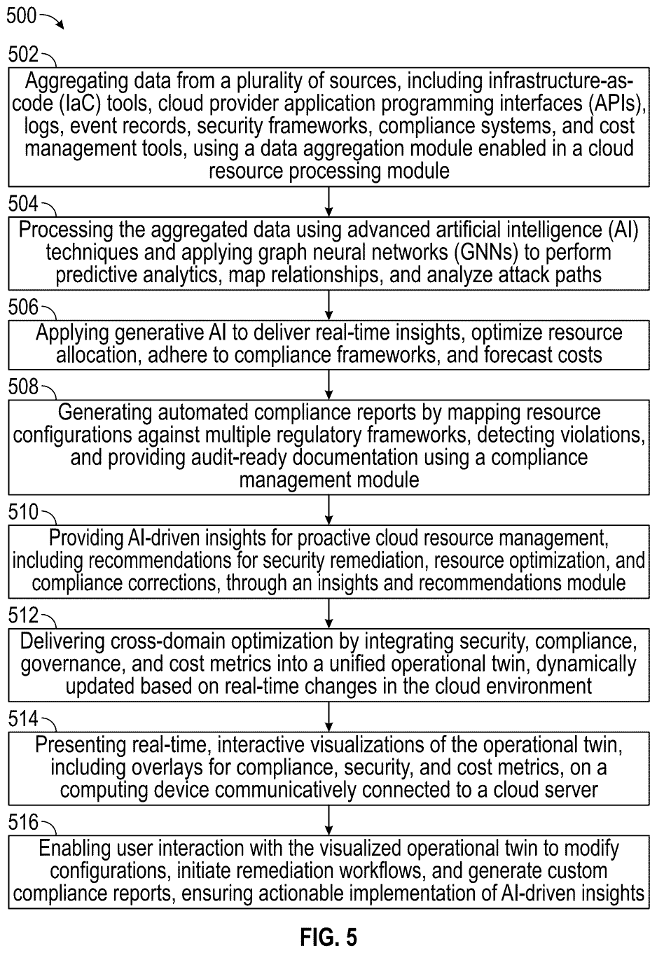

Referring to FIG. 5 is a flow diagram 500 depicting a method for integrating predictive GNN analytics, AI-driven insights, and automated compliance reporting to deliver cross-domain cloud infrastructure optimization, in accordance with one or more exemplary embodiments. The method 500 may be carried out in the context of the details of FIG. 1, FIG. 2, FIG. 3, and FIG. 4. However, the method 500 may also be carried out in any desired environment. Further, the aforementioned definitions may equally apply to the description below.

The exemplary method 500 commences at step 502, aggregating data from a plurality of sources, including Infrastructure-as-Code (IaC) tools, cloud provider application programming interfaces (APIs), logs, event records, security frameworks, compliance systems, and cost management tools, using the data aggregation module enabled in the cloud resource processing module. Thereafter at step 504, processing the aggregated data using advanced artificial intelligence (AI) techniques and applying Graph Neural Networks (GNNs) to perform predictive analytics, map relationships, and analyze attack paths. Thereafter at step 506, applying Generative AI to deliver real-time insights, optimize resource allocation, adhere to compliance frameworks, and forecast costs. Thereafter at step 508, generating automated compliance reports by mapping resource configurations against multiple regulatory frameworks, detecting violations, and providing audit-ready documentation using the compliance management module. Thereafter at step 510, providing AI-driven insights for proactive cloud resource management, including recommendations for security remediation, resource optimization, and compliance corrections, through the insights and recommendations module. Thereafter at step 512, delivering cross-domain optimization by integrating security, compliance, governance, and cost metrics into a unified operational twin, dynamically updated based on real-time changes in the cloud environment. Thereafter at step 514, presenting real-time, interactive visualizations of the operational twin, including overlays for compliance, security, and cost metrics, on the computing device communicatively connected to the cloud server. Thereafter at step 516, enabling user interaction with the visualized operational twin to modify configurations, initiate remediation workflows, and generate custom compliance reports, ensuring actionable implementation of AI-driven insights.

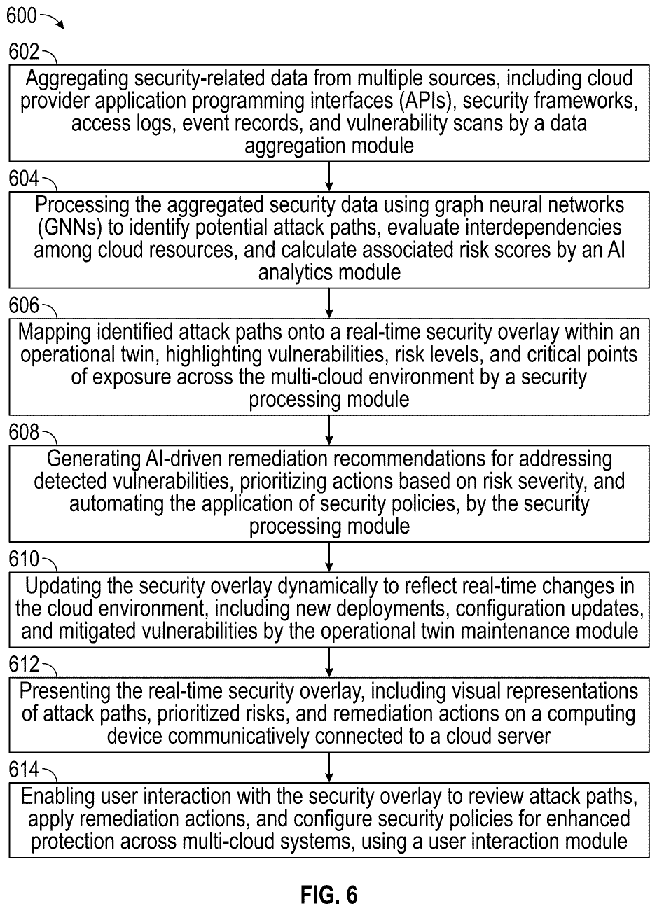

Referring to FIG. 6 is a flow diagram 600 depicting a method for proactive attack path detection and remediation using Graph Neural Networks (GNNs), integrated into a real-time security overlay for multi-cloud systems. The method 600 may be carried out in the context of the details of FIG. 1, FIG. 2, FIG. 3, FIG. 4, and FIG. 5. However, the method 600 may also be carried out in any desired environment. Further, the aforementioned definitions may equally apply to the description below.

The exemplary method 600 commences at step 602, aggregating security-related data from multiple sources, including cloud provider application programming interfaces (APIs), security frameworks, access logs, event records, and vulnerability scans by the data aggregation module. Thereafter at step 604, processing the aggregated security data using Graph Neural Networks (GNNs) to identify potential attack paths, evaluate interdependencies among cloud resources, and calculate associated risk scores by the AI analytics module. Thereafter at step 606, mapping identified attack paths onto a real-time security overlay within an operational twin, highlighting vulnerabilities, risk levels, and critical points of exposure across the multi-cloud environment by the security processing module. Thereafter at step 608, generating AI-driven remediation recommendations for addressing detected vulnerabilities, prioritizing actions based on risk severity, and automating the application of security policies, by the security processing module. Thereafter at step 610, updating the security overlay dynamically to reflect real-time changes in the cloud environment, including new deployments, configuration updates, and mitigated vulnerabilities by the operational twin maintenance module. Thereafter at step 612, presenting the real-time security overlay, including visual representations of attack paths, prioritized risks, and remediation actions on the computing device communicatively connected to the cloud server. Thereafter at step 614, enabling user interaction with the security overlay to review attack paths, apply remediation actions, and configure security policies for enhanced protection across multi-cloud systems using the user interaction module.

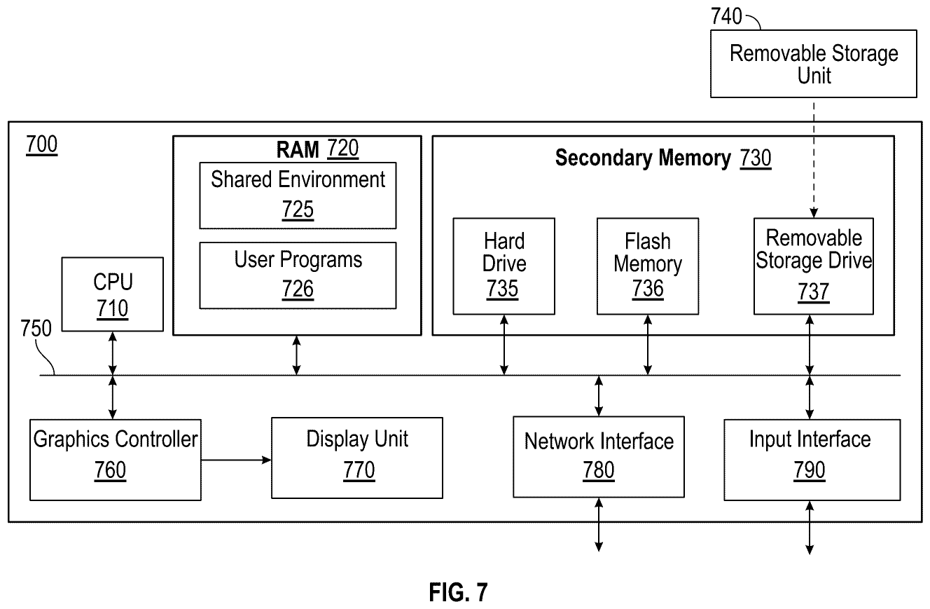

Referring to FIG. 7 is a block diagram 700 illustrating the details of a digital processing system 700 in which various aspects of the present disclosure are operative by execution of appropriate software instructions. The Digital processing system 700 may correspond to the computing devices (or any other system in which the various features disclosed above can be implemented).

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions, such as those used in threads and stacks, constituting shared environment 725 and/or user programs 726. Shared environment 725 includes operating systems, device drivers, virtual machines, etc., which provide a (common) run time environment for execution of user programs 726.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touchpad, mouse) and may be used to provide inputs. Network interface 780 provides connectivity to a network (e.g., using Internet Protocol), and may be used to communicate with other systems (such as those shown in FIG. 1) connected to the network 104.

Secondary memory 730 may contain hard drive 735, flash memory 736, and removable storage drive 737. Secondary memory 730 may store the data software instructions (e.g., for performing the actions noted above with respect to the Figures), which enable digital processing system 700 to provide several features in accordance with the present disclosure.

Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EEPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 750. Transmission media can also take the form of acoustic or light waves, such as those generated during radio-wave and infra-red data communications.

In accordance with one or more exemplary embodiments of the present disclosure, the cloud resource processing module 114 may include the data aggregation module 302. The data aggregation module 302 may be configured to aggregate real-time data from a plurality of sources, including Infrastructure-as-Code (IaC) tools, cloud provider application programming interfaces (APIs), application logs, and compliance systems, ensuring unified visibility into the cloud environment.

In accordance with one or more exemplary embodiments of the present disclosure, the cloud resource processing module 114 may include the AI analytics module 304. The AI analytics module 304 may be configured to employ Graph Neural Networks (GNNs) for relationship mapping, predictive analytics, and attack path analysis within the cloud ecosystem.

In accordance with one or more exemplary embodiments of the present disclosure, the cloud resource processing module 114 may include the AI analytics module 304. The AI analytics module 304 may be configured to utilize Generative AI for real-time resource optimization, compliance adherence, and pre-deployment cost forecasting during the design phase.

In accordance with one or more exemplary embodiments of the present disclosure, the cloud resource processing module 114 may include the security processing module 306. The security processing module 306 may be configured to evaluate the security posture of the cloud environment, identify vulnerabilities, and automate remediation workflows.

In accordance with one or more exemplary embodiments of the present disclosure, the cloud resource processing module 114 may include the compliance management module 308. The compliance management module 308 may be configured to map cloud resource configurations against multiple regulatory frameworks and generate audit-ready compliance reports.

In accordance with one or more exemplary embodiments of the present disclosure, the cloud resource processing module 114 may include the visualization data preparation module 310. The visualization data preparation module 310 may be configured to process and format aggregated data for rendering in the cloud resource visualization module.

In accordance with one or more exemplary embodiments of the present disclosure, the cloud resource processing module 114 may include the resource optimization module 312. The resource optimization module 312 may be configured to recommend adjustments to resource allocations for cost and performance optimization based on workload demands.

In accordance with one or more exemplary embodiments of the present disclosure, the cloud resource processing module 114 may include the operational twin maintenance module 314. The operational twin maintenance module 314 may be configured to create and dynamically update a digital twin of the cloud ecosystem in real-time, reflecting changes in deployments, configurations, and detected issues.

In accordance with one or more exemplary embodiments of the present disclosure, the cloud resource visualization module 112 may include the visualization module 202. The visualization module 202 may be configured to display interactive visualizations of the operational twin, including overlays for compliance, security, and cost metrics.

In accordance with one or more exemplary embodiments of the present disclosure, the cloud resource visualization module 112 may include the user interaction module 204. The user interaction module 204 may be configured to enable users to initiate remediation workflows, modify cloud configurations, and generate compliance reports through an intuitive interface.

In accordance with one or more exemplary embodiments of the present disclosure, the cloud resource visualization module 112 may include the insights and recommendations module 206. The insights and recommendations module 206 may be configured to present AI-driven insights for proactive decision-making, including suggestions for security improvements and resource optimizations.

In accordance with one or more exemplary embodiments of the present disclosure, the cloud resource visualization module 112 may include the data synchronization module 208. The data synchronization module 208 may be configured to synchronize real-time data between the cloud server and the computing device, ensuring consistency in the operational twin visualizations.

In accordance with one or more exemplary embodiments of the present disclosure, the cloud resource visualization module 112 may include the alert and notification module 210. The alert and notification module 210 may be configured to generate alerts categorized by severity for events, including security vulnerabilities, compliance violations, and cost anomalies.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A system for real-time cloud resource monitoring and visualization, comprising:
a computing device comprising a processor for executing instructions from a cloud resource visualization module located within the computing device, wherein the cloud resource visualization module is configured to display real-time visualizations of cloud resources, including operational states, interdependencies, and relationships, wherein the computing device communicatively connected with a cloud server over a network;
the cloud server comprises an operational twin engine for executing instructions from a cloud resource processing module, whereby the cloud resource processing module configured to aggregate data from a plurality of sources, including infrastructure-as-Code (IaC) tools, cloud provider application programming interfaces (APIs), logs and event records, security frameworks and compliance systems, cost management tools, wherein the cloud resource processing module configured to process the aggregated data using advanced artificial intelligence (AI) techniques, including Graph Neural Networks (GNNs) for predictive analytics, relationship mapping, and attack path analysis; Generative AI for real-time optimization of resource allocation, compliance adherence, and cost forecasting;
the cloud resource processing module generates a real-time operational twin of the cloud ecosystem with visual representations of cloud resource relationships, performance metrics, compliance statuses, security vulnerabilities, dynamic updates of changes in the cloud environment, including new deployments, configuration changes, and detected issues, whereby the cloud resource processing module transmits the generated real-time operational twin of the cloud ecosystem to the computing device over the network; and
the cloud resource visualization module on the computing device configured to provide real-time, interactive visualizations of the operational twin, including overlays for compliance, security, and cost metrics, and presents AI-driven insights and recommendations for proactive decision-making, such as security remediation, resource optimization, and compliance corrections, wherein the cloud resource visualization module configured to enable the user to interact with visual elements, including modifying configurations, initiating remediation workflows, and generating compliance reports.

2. The system of claim 1, wherein the cloud resource processing module comprises a data aggregation module configured to aggregate real-time data from a plurality of sources, including Infrastructure-as-Code (IaC) tools, cloud provider application programming interfaces (APIs), application logs, and compliance systems, ensuring unified visibility into the cloud environment.

3. The system of claim 1, wherein the cloud resource processing module comprises an AI analytics module configured to employ Graph Neural Networks (GNNs) for relationship mapping, predictive analytics, and attack path analysis within the cloud ecosystem.

4. The system of claim 1, wherein the cloud resource processing module comprises an AI analytics module configured to utilize Generative AI for real-time resource optimization, compliance adherence, and pre-deployment cost forecasting during the design phase.

5. The system of claim 1, wherein the cloud resource processing module comprises a security processing module configured to evaluate the security posture of the cloud environment, identify vulnerabilities, and automate remediation workflows.

6. The system of claim 1, wherein the cloud resource processing module comprises a compliance management module configured to map cloud resource configurations against multiple regulatory frameworks and generate audit-ready compliance reports.

7. The system of claim 1, wherein the cloud resource processing module comprises a visualization data preparation module configured to process and format aggregated data for rendering in the cloud resource visualization module.

8. The system of claim 1, wherein the cloud resource processing module comprises a resource optimization module configured to recommend adjustments to resource allocations for cost and performance optimization based on workload demands.

9. The system of claim 1, wherein the cloud resource processing module comprises an operational twin maintenance module configured to create and dynamically update a digital twin of the cloud ecosystem in real-time, reflecting changes in deployments, configurations, and detected issues.

10. The system of claim 1, wherein the cloud resource visualization module comprises a visualization module configured to display interactive visualizations of the operational twin, including overlays for compliance, security, and cost metrics.

11. The system of claim 1, wherein the cloud resource visualization module comprises a user interaction module configured to enable users to initiate remediation workflows, modify cloud configurations, and generate compliance reports through an intuitive interface.

12. The system of claim 1, wherein the cloud resource visualization module comprises an insights and recommendations module configured to present AI-driven insights for proactive decision-making, including suggestions for security improvements and resource optimizations.

13. The system of claim 1, wherein the cloud resource visualization module comprises a data synchronization module configured to synchronize real-time data between the cloud server and the computing device, ensuring consistency in the operational twin visualizations.

14. The system of claim 1, wherein the cloud resource visualization module comprises an alert and notification module configured to generate alerts categorized by severity for events, including security vulnerabilities, compliance violations, and cost anomalies.

15. A method for real-time cloud resource monitoring and visualization, comprising:
displaying real-time visualizations of cloud resources, including operational states, interdependencies, and relationships by a cloud resource visualization module enabled on a computing device;
aggregating data from a plurality of sources, including infrastructure-as-Code (IaC) tools, cloud provider application programming interfaces (APIs), logs and event records, security frameworks and compliance systems, and cost management tools by a cloud resource processing module enabled in a cloud server;
processing the aggregated data using advanced artificial intelligence (AI) techniques, including Graph Neural Networks (GNNs) for predictive analytics, relationship mapping, and attack path analysis, and Generative AI for real-time optimization of resource allocation, compliance adherence, and cost forecasting by the cloud resource processing module;
generating a real-time operational twin of the cloud ecosystem with visual representations of cloud resource relationships, performance metrics, compliance statuses, security vulnerabilities, and dynamic updates of changes in the cloud environment by the cloud resource processing module;
transmitting the generated real-time operational twin of the cloud ecosystem from the cloud server to the computing device over the network;
providing real-time, interactive visualizations of the operational twin on the computing device, including overlays for compliance, security, and cost metrics;
presenting AI-driven insights and recommendations for proactive decision-making, including security remediation, resource optimization, and compliance corrections on the computing device; and
enabling user interaction with the visual elements of the operational twin on the computing device, including modifying configurations, initiating remediation workflows, and generating compliance reports.
